(19) United States
(12) Patent Application Publication
(10) Pub. No.: US 2008/0082257 A1
(43) Pub. Date: Apr. 3, 2008

(54) PERSONAL NAVIGATIONAL DEVICE AND METHOD WITH AUTOMATIC CALL-AHEAD

(75) Inventor: Choy Wai Lee, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town, KY (US)

(21) Appl. No.: 11/470,193

(22) Filed: Sep. 5, 2006

(51) Int. Cl. G01C 21/00

(52) U.S. Cl. 701/204

(57) ABSTRACT

An electronic personal navigational aid device configured to calculate a route and to automatically call a telephone number and deliver a message depending upon the location of the device along the route. The devices may further be configured, for example, to dial at a certain estimated time enroute to a delivery or pickup stop and/or to listen to an autodialed party to determine how many packages the autodialed party has for pickup.

### BACKGROUND OF THE INVENTION

This invention relates generally to navigational aid devices, and more particularly, to personal navigational aid devices that can initiate calls to parties at stops along a route.

Route planning devices are well known in the field of navigational instruments. One feature of increased system capability involves off-route recalculation capabilities. Navigational route planning devices are now known that can provide these capabilities. However, there are instances in which individuals other than drivers may be interested in results of route calculations.

One of the most time-consuming activities undertaken by a delivery truck driver is a stop that requires a customer signature. On most other types of stops, the driver can simply leave a package, ring the doorbell, and leave, if it is safe to do so. But for stops that require customer signatures, the driver has to wait for someone to show up at the door and sign for a package or allow the driver to make a pickup.

United States Patent Application Publication Nos. US2006/0111955A1 and US2006/0111089 teach a server-based system for transmitting to a customer a notification of a pending arrival of a mobile agent at the customer location for an appointment and receiving a confirmation from the customer confirming the appointment. The system described in these applications also includes a mobile agent communication module configured for transmitting a schedule and customer appointment information to the mobile agent in response to receiving the customer confirmation. However, the system described is a server-based system, and as such, is dependent upon a server at a centralized location for its operation. Furthermore, the system described is essentially a dispatcher system, and therefore also suffers from problems of dispatching systems, such as being labor intensive (requiring a dispatcher) and being more complex, expensive, and dependent on multiple communications links.

### BRIEF DESCRIPTION OF THE INVENTION

In one aspect, some configurations of the present invention therefore provide an electronic personal navigational aid device that comprises a position determining module configured to determine a position of the device, a route calculating module configured to calculate a route along which the device is to travel, and a contact module configured to automatically call a contact number and deliver a message based on a location of the device along the route. The devices may further be configured to, for example, call at a certain estimated time enroute and/or to determine how many packages the called party has for pickup.

In yet another aspect, some configurations of the present invention provide a device configured to automatically deliver a text message or email to a telephone or pager. In some configurations of the present invention, an electronic personal navigational aid device is provided that is configured to calculate a route and to autodial a phone number associated with a delivery or pickup address, and to connect a driver with an autodialed party.

It will be appreciated that various configurations of the present invention can provide advance warning of an impending delivery or pickup to a customer, making it possible for the person to be ready for the driver when he or she arrives without the driver having to remember to call ahead at any particular time. Because the device requires little or no interaction with the driver, driver safety is not compromised, yet efficiency is increased because the likelihood of a driver having to wait a long time for someone to show up for a signature is reduced.

### BRIEF DESCRIPTION OF THE DRAWINGS

FIG. 1 is a representative view of a Global Positioning System (GPS).

FIGS. 2A-2C illustrate views for an embodiment of an electronic personal navigational device according to the teachings of the present invention.

FIG. 3 is a block diagram of electronic components within the device of FIGS. 2A-2C according to the teachings of the present invention.

FIG. 4 is a block diagram of a navigation system according to the teachings of the present invention.

FIG. 5 is a flow diagram of the present invention.

FIG. 6 is another flow diagram of the present invention.

FIG. 7 illustrates views of a personal navigational aid device that includes an integral package scanner and that can communicate wirelessly with a separate package scanner.

The foregoing summary, as well as the following detailed description of certain embodiments of the present invention, will be better understood when read in conjunction with the appended drawings. To the extent, that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware such as a general purpose signal processor, a block of random access memory, hard disk, or the like. Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description of the invention, reference is made to the accompanying drawings which form a part hereof, and in which is shown, by way of illustration, specific embodiments in which the invention may be practiced. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense, and the scope of the present invention is defined only by the appended claims, along with the full scope of equivalents to which such claims are entitled.

The present invention is drawn to navigational systems and devices having route calculation capabilities. One type of navigational system includes Global Positioning Systems (GPS). In general, GPS is a satellite-based radio navigation system capable of determining continuous position, velocity, time, and in some instances direction information for an unlimited number of users. Formally known as NAVSTAR, the GPS incorporates a plurality of satellites which orbit the earth in extremely precise orbits.

The GPS system is implemented when a device specially equipped to receive GPS data begins scanning radio frequencies for GPS satellite signals. The device will continue scanning for signals until it has acquired at least three different satellite signals. Implementing geometric triangulation, the receiver determines its own two-dimensional position. Additionally, acquiring a fourth satellite signal will allow the receiving device to calculate its three-dimensional position by the same geometrical calculation. Positioning and velocity data can be updated in real time on a continuous basis by an unlimited number of users.

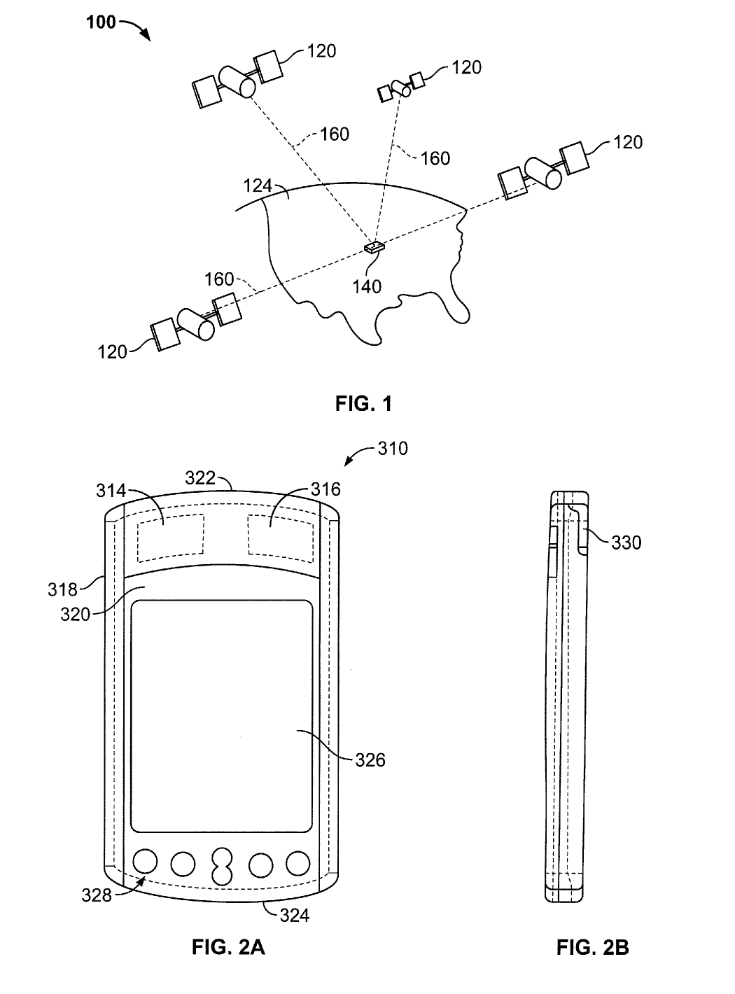

FIG. 1 is representative of a GPS denoted generally by reference numeral 100. A plurality of satellites 120 are in orbit about the Earth 124. The orbit of each satellite 120 is not necessarily synchronous with the orbits of other satellites 120 and, in fact, is likely asynchronous. A GPS receiver device 140 in one configuration of the present invention is shown receiving spread spectrum GPS satellite signals 160 from the various satellites 120.

The spread spectrum signals 160 continuously transmitted from each satellite 120 utilize a highly accurate frequency standard accomplished with an extremely accurate atomic clock. Each satellite 120, as part of its data signal transmission 160, transmits a data stream indicative of that particular satellite 120. GPS receiver device 140 must acquire spread spectrum GPS satellite signals 160 from at least three satellites 120 for the GPS receiver device 140 to calculate its two-dimensional position by triangulation. Acquisition of an additional signal 160, resulting in signals 160 from a total of four satellites 120, permits GPS receiver device 140 to calculate its three-dimensional position.

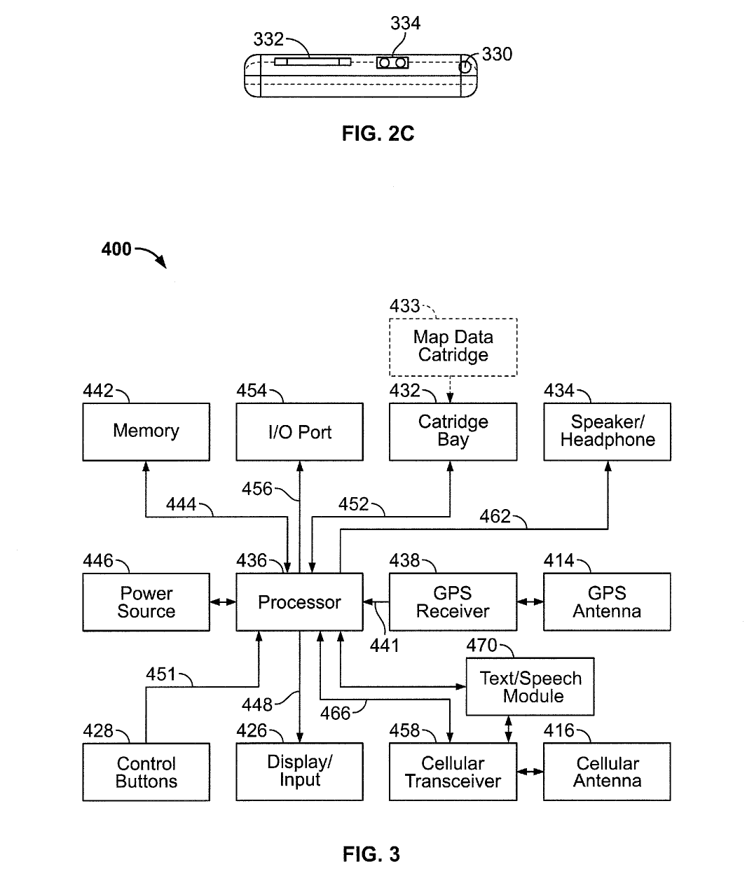

FIGS. 2A-2C illustrate views of an electronic personal navigational device 310 according to the teachings of the present invention. As will be explained below in more detail, the device 310 represents an electronic personal navigational aid device that comprises a position determining module configured to determine a position of the device, a route calculating module configured to calculate a route along which the device is to travel, and a contact module configured to automatically call a contact number and deliver a predetermined message based on a location of the device along the route.

The device 310 shown in FIGS. 2A-2C can be a personal digital assistant (PDA) with integrated GPS receiver and cellular transceiver according to the teachings of the present invention. Although, in some other configurations, the PDA may be omitted. The device 310 operates with an operating system (OS) such as, for example, the Palm or Pocket PC operating systems, or the Linux operating system. As shown in the top view of FIG. 2A, the device 310 includes an internal integrated GPS patch antenna 314 and a cellular transceiver 316 contained in a housing 318. The housing 318 may be generally rectangular with a low profile and may have a front face 320 extending from a top end 322 to a bottom end 324. Mounted on front face 320 is a display screen 326, which may be touch sensitive and responsive to a stylus 330 (shown stored in the side view of FIG. 2B) or a finger touch. FIGS. 2A-2C illustrate the stylus 330 nested within housing 318 for storage and convenient access in a conventional manner. The embodiment shown in FIG. 2A illustrates a number of control buttons, or input keys 328 positioned toward the bottom end 324. The invention, however, is not so limited and one of ordinary skill in the art will appreciate that the input keys 328 can be positioned toward the top end 322 or at any other suitable location. The end view of FIG. 2C illustrates a map data cartridge bay slot 332 and headphone jack 334 provided at the top end 322 of the housing 318. Again, the invention is not so limited and one of ordinary skill in the art will appreciate that a map data cartridge bay slot 332 and headphone jack 334 can be provided at the bottom end 324, separately at opposite ends, or at any other suitable location, or may be omitted altogether in configurations in which map data is stored internally.

It should be understood that the device 310 of FIG. 2A-2C is representative of the structure of device 310 and is illustrative of one type of integrated PDA navigation device. Other physical structures of personal navigation devices with or without an integrated PDA, such as a cellular telephone and a vehicle-mounted unit, are also contemplated to be within the scope of this invention.

FIGS. 2A-2C illustrate examples of components for a personal navigational device according to an embodiment of the present invention. However, the invention is not limited to the configuration shown in FIGS. 2A-2C. One of ordinary skill in the art will appreciate other suitable designs for a hardware device that can accommodate the present invention.

FIG. 3 is a block diagram electronic components 400 within the device 310 of FIGS. 2A-2C and utilized by the device 310 according to the teachings of the present invention. The electronic components 400 shown in FIG. 3 include a processor 436 that is connected to a GPS antenna 414 through a GPS receiver 438 via line 441. The processor 436 interacts with an operating system (such as PalmOS; Pocket PC, or Linux) that runs selected software depending on the intended use of the device 310. The processor 436 is coupled with a memory 442 via line 444 and a power source 446 for powering the electronic components 400 of the device 310. The processor 436 communicates with a touch sensitive display screen 426 via line 448.

The electronic components 400 further include two other input sources that are connected to the processor 436. Control buttons 428 are connected to the processor 436 via line 451 and a map data cartridge 433 inserted into a cartridge bay 432 is connected via line 452. A conventional serial I/O port 454 is connected to the processor 436 via line 456. A cellular antenna 416 is connected to a cellular transceiver 458, which is connected to the processor 436 via line 466. The processor 436 is connected to a speaker/headphone jack 434 via line 462. The device 310 may also include an infrared port (not shown) coupled to the processor 436 that may be used to beam information from one PDA to another. In addition, the device 310 may include a real time clock or the capability of determining an accurate real time based upon received GPS signals.

Advantageously, in some configurations, the processor 436 is configured to activate the cellular transceiver 458 to call a telephone number while the device 310 is enroute to a location with which the number is associated. For example, a message may be sent via the processor 436 and the cellular transceiver 458 to a customer announcing that a package is about to be delivered. The message may be prerecorded and stored in memory 442. For example, where the device 310 always calls five minutes ahead, the message may be a prerecording informing the customer that the package is five minutes away. The message may also be created on the fly. For example, where the device 310 calls five minutes ahead, but does not get through until three minutes before arrival, the message may be modified to inform the customer that the package is three minutes away.

The time that the telephone number is called and/or the number being called may depend upon the location of the device 310, so that the customer is automatically alerted to be ready to accept delivery or be ready for pickup in advance of a user/driver's arrival. By alerting the customer in this way, the driver of a delivery truck may be able to reduce the amount of time spent waiting for the customer to come to the door when the customer's signature is required for that stop. The telephone number can be entered, for example, using the touch screen 426 and stored in the memory 442 by a driver carrying the personal navigational device in his or her truck. The telephone number can be a number associated with particular delivery or pickup address on the driver's route or itinerary, which may also be entered, for example, using touch screen 426. As parameters of the route are calculated in a manner discussed below, the number is dialed at an appropriate time to alert the customer of an imminent delivery or pickup.

The use of the phrase “cellular transceiver” is not meant to exclude from the present invention configurations using different types of mobile telephone technologies that may not use a cellular configuration, such as specialized mobile radio (SMR) technology or trunking radio systems with telephone interconnections, etc. Furthermore, while shown being integral to the device 310, the cellular transceiver 458 may be external to the device 310. In this case, the processor 436 may instruct the external cellular transceiver 458, over a Bluetooth connection for example, to place the call and the device 310 may operate as a hands-free accessory to the external cellular transceiver 458.

In some configurations, instead of or in addition to calling a number, the processor 436 is configured to deliver a text message or email message to a telephone or pager selected in accordance with the location of the device 310. The cellular transceiver 458 may be used to deliver the text message or email message, or the device 310 may be provided with another type of public or private wireless network transceiver for this purpose.

In some configurations of the present invention, the processor 436 is configured to accept a number of stops or addresses, or a complete itinerary or route, with phone numbers of the delivery or pickup addresses. For example, such information may be stored in the memory 442 after having been entered by a user using the touch screen 426, entered via the I/O port 454, entered via the cellular transceiver 458, or entered in any other suitable manner, depending upon inputs present in the device 310. In some configurations, the processor 436 calculates the route, an estimated time enroute (ETE), an estimated time of arrival (ETA), or a distance to the next delivery or pickup stop, or any combination thereof, and includes the calculated information for the delivery or pickup stop in the message that is delivered to the customer at each delivery or pickup address. In at least one configuration of the present invention, the automatic call to a customer is placed at a particular estimated time enroute to a delivery or pickup, such as, for example, five minutes before the estimated time remaining. Also, in some configurations, a delivery or pickup appointment time is stored for delivery or pickup addresses, so that, under appropriate conditions, the telephone message delivered to a customer can include information that a delivery or pickup will be early, on time, or late.

In at least one configuration of the present invention, rather than automatically deliver a message, the device 310 is configured to automatically dial the party at the delivery or pickup address and prompts the driver regarding what to say to the autodialed party. For example, five minutes before arrival at a destination address, the processor 436 may be configured to transfer the number associated with the delivery or pickup address from the memory 442 to the cellular transceiver 458 and to trigger the cellular transceiver 458 to dial that number. In the meantime, the processor 436 may read from the memory 442 and/or calculate information and display the information read and/or calculated on the touch screen 426 to alert the driver that a phone call is being made and to instruct the driver regarding what to say to the autodialed party.

Some or all of the stops made by some delivery trucks may include stops to pick up packages. Prior to such stops, it may be necessary to ascertain how many packages are being held for pickup, if any. Thus, some configurations of the present invention include a text/speech conversion module 470, which may be configured to convert speech to text, text to speech, or both. In some configurations, the module 470 is used to either speak to an autodialed party or to listen for whether the autodialed party has any packages (and if so, how many) for pickup, or both.

In some configurations of the present invention, the device 310 accounts for changes in delivery, timing, and/or routing during a trip. For example, the device 310 recognizes (or is told via touch screen 426, for example) when the device 310 has deviated from the route. The device 310 then selects an appropriate starting point for performing a new route calculation and uses its electronic components to calculate a new route to navigate to the desired destination. According to the teachings of the present invention, the device adjusts a starting point for the new route calculation to a location forward along a current thoroughfare on which the device is located or traveling such that the location is at or forward of the device at a time when the new route calculation is completed. In other words, the device adjusts a starting point for the new route calculation to a location forward along a current thoroughfare on which the device is located or traveling such that the device is on the route at a time when the new route calculation is completed. According to the teachings of the present invention, the device incorporates these and other functions as will be explained in more detail below.

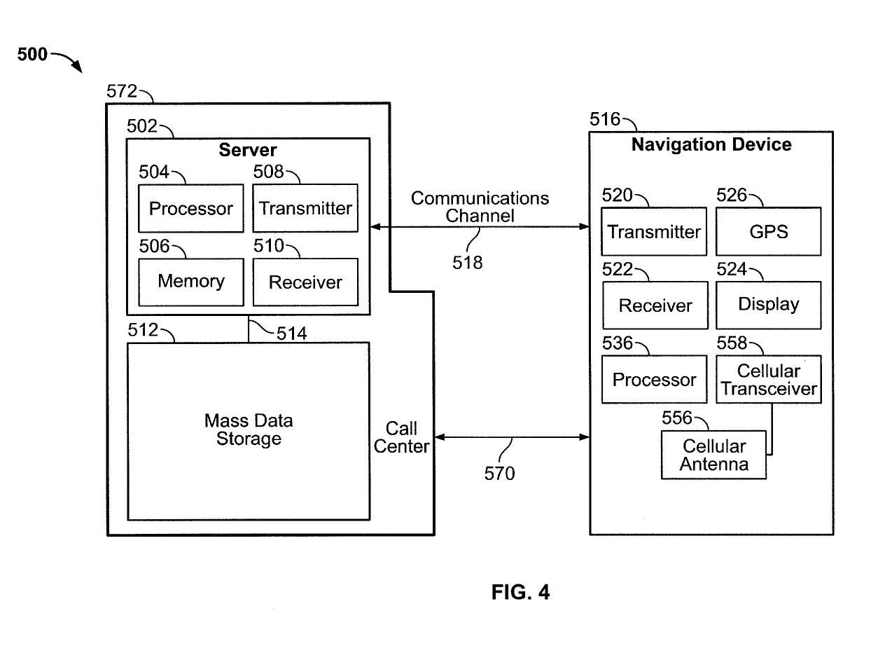

FIG. 4 is a block diagram of an embodiment of a navigation system 500 which can be adapted to the teachings of the present invention. The navigation system 500 includes a server 502. According to one embodiment, the server 502 includes a processor 504 operably coupled to memory 506, and further includes a transmitter 508 and a receiver 510 to send and receive data, communication, and/or other propagated signals. The transmitter 508 and receiver 510 are selected or designed according to the communication requirements and the communication technology used in the communication design for the navigation system. The functions of the transmitter 508 and the receiver 510 may be combined into a single transceiver.

The navigation system f500 urther includes a mass data storage 512 coupled to the server 502 via communication link 514. The mass data storage 512 contains a store of navigation data. One of ordinary skill in the art will understand, upon reading and comprehending this disclosure, that the mass data storage 512 can be separate from the server 502 or can be incorporated into the server 502.

In one embodiment of the present invention, the navigation system 500 further includes a navigation device 516 adapted to communicate with the server 502 through a communications channel 518. According to one embodiment, the device 516 includes a processor 536 and memory, as previously shown and described with respect to the block diagram of FIG. 3. Furthermore, the device 516 includes a transmitter 520 and receiver 522 to send and receive communication signals through the communications channel 518. The transmitter 520 and receiver 522 are selected or designed according to the communication requirements and the communication technology used in the communication design for the navigation system 500. The functions of the transmitter 520 and receiver 522 may be combined into a single transceiver. The device 516 may be similar or identical to the device 310 discussed above.

Software stored in the server memory 506 provides instructions for the processor 504 and allows the server 502 to provide services to the navigation device 516. One service provided by the server 502 involves processing requests from the navigation device 516 and transmitting navigation data from the mass data storage device 512 to the navigation device 516. According to one embodiment, another service provided by the server 502 includes processing the navigation data using various algorithms for a desired application, and sending the results of these calculations to the navigation device 516.

The communications channel 518 is the propagating medium or path that connects the navigation device 516 and the server 502. According to one embodiment, both the server 502 and the navigation device 516 include a transmitter for transmitting data through the communication channel and a receiver for receiving data that has been transmitted through the communication channel.

The communications channel 518 is not limited to a particular communication technology. Additionally, the communications channel 518 is not limited to a single communication technology; that is, the channel 518 may include several communication links that use a variety of technology. For example, according to various embodiments, the communication channel is adapted to provide a path for electrical, optical, and/or electromagnetic communications. As such, the communication channel includes, but is not limited to, one or a combination of the following: electrical circuits, electrical conductors such as wires and coaxial cables, fiber optic cables, converters, radio-frequency (RF) waveguides, the atmosphere, and empty space. Furthermore, according to various embodiments, the communication channel includes intermediate devices such as routers, repeaters, buffers, transmitters, and receivers, for example.

In one embodiment, for example, the communications channel 518 includes a telephone network (which may include or consist of a cellular telephone network) and a computer network. Furthermore, in various embodiments, the communications channel 518 is capable of accommodating wireless communication such as radio frequency, microwave frequency and infrared communication, and the like. Additionally, according to various embodiments, the communications channel 518 accommodates satellite communication.

The communication signals transmitted through the communications channel 518 include such signals as may be required or desired for a given communication technology. For example, the signals may be adapted to be used in cellular communication technology, such as time division multiple access (TDMA), frequency division multiple access (FDMA), code division multiple access (CDMA), global system for mobile communications (GSM), and the like. Both digital and analog signals may be transmitted through the communications channel 518. According to various embodiments, these signals are modulated, encrypted and/or compressed as may be desirable for the communication technology.

The mass data storage 512 includes sufficient memory for the desired navigation application. Examples of mass data storage include magnetic data storage media such as hard drives, optical data storage media such as CD ROMs, charge storing data storage media such as Flash memory, and molecular memory, such as now known or hereinafter developed.

According to one embodiment of the navigation system 500, the server 502 includes a remote server accessed by the navigation device 516 through a wireless channel. According to other embodiments of the navigation system 500, the server 502 includes a network server located on a local area network (LAN), wide area network (WAN), a virtual private network (VPN) and server farms.

According to another embodiment of the navigation system 500, the server 502 includes a personal computer such as a desktop or laptop computer. In one embodiment, the communications channel 518 is a cable connected between the personal computer and the navigation device 516. According to one embodiment, the communications channel 518 is a wireless connection between the personal computer and the navigation device 516.

Also, according to yet another embodiment of the navigation system, a communications channel 570 is provided to communicate status information to a call center 572, which may but need not include live operators. The communication channel need not be different from the communications channel 518, or may include a cellular or other type of telephone channel and use a cellular transceiver 458 such as that shown in FIG. 3, for example. The status information may include, for example, location, number of packages to pick up at each location, estimated time to the next and/or subsequent stops, other related information, or any combination thereof. The call center 572 may itself include or consist of server 502 and mass data storage 512, which may itself include a database of customer data. This customer data may include phone numbers, addresses, pickup hours, package data, customer and/or package priorities, or any combination thereof, and/or other information. This customer data may be used by call center operators, by a billing center, or some or all of the data may be transmitted back to the device 516. For example, if the customer data indicates that it is too late or too early to pick up or deliver a package, or if there is no package to pick up or deliver to a particular scheduled location, routing information may be changed accordingly in the device 516, thereby changing a generated route while enroute to a delivery or pickup, in accordance with delivery or pickup conditions on the route.

FIG. 4 presents yet another embodiment for a collective set of electronic components adapted to the present invention. As one of ordinary skill in the art will understand upon reading and comprehending this disclosure, the navigation system 500 of FIG. 4 may be adapted to the present invention in a manner distinguishable from that described and explained in detail in connection with FIG. 3.

The navigational system 500 of FIG. 4 is adapted to remotely provide the device 516 with route calculation capabilities. In this embodiment, the processor 504 in the server 502 is used to handle the bulk of the system's processing needs. The mass data storage 512 connected to the server 502 can include significantly more cartographic and route data than that which can be maintained on the device 516 itself. In this embodiment, the server 502 processes the majority of a device's 516 travel along the route using a set of processing algorithms and the cartographic and route data stored in memory (e.g., mass data storage 512) and can operate on signals, e.g. GPS signals, originally received by the device 516. Similar to the device of FIGS. 2 and 3, the device 516 in system 500 is outfitted with a display 524 (which may also include input capabilities), GPS capabilities 526, a processor 536 and any associated memory, a cellular transceiver 558, and a cellular antenna 556.

As described and explained in detail in connection with FIGS. 2 and 3, the navigation system 500 of FIG. 4 uses processing algorithms to select an appropriate starting point for performing a new route calculation. The system 500 also uses the processing algorithms to recognize when the device has deviated from the route and to perform a new route calculation. The system 500 then selects the appropriate starting point and calculate a new route for navigating the device 516 to the desired destination. As one of ordinary skill in the art will understand upon reading and comprehending this disclosure, a user of the navigation device 516 can be proximate to or accompanying the device 516. The invention however, is not so limited.

According to the teachings of the present invention, the system 500 adjusts a starting point for the new route calculation to a location forward along a current thoroughfare on which the device is located or traveling such that the location is at or forward of the device at a time when the new route calculation is completed. In other words, the device adjusts a starting point for the new route calculation to a location forward along a current thoroughfare on which the device is located or traveling such that the device is on the route at a time when the new route calculation is completed. The navigation device 516 of the present invention includes a portable electronic personal navigational aid device. In one embodiment, the portable electronic personal navigational aid device includes a personal digital assistant (PDA). In one embodiment, the portable electronic personal navigational aid device includes a wireless communications device.

Alternatively, the server 502 and the mass data storage 512 may act as a remote data repository for the device 516. For example, the device 516 may determine where it is and receive indication of a destination from the user. Then, the device 516 may request and receive map data from the server 502. In this manner, the device 516 may calculate the route itself, without having to store large maps unrelated to the route.

The features and functionality explained and described in detail above in connection with the device of FIG. 3 are likewise available in the system 500 of FIG. 4. That is, in one embodiment the device 516 further provides audio and visual cues to aid the navigation along the route.

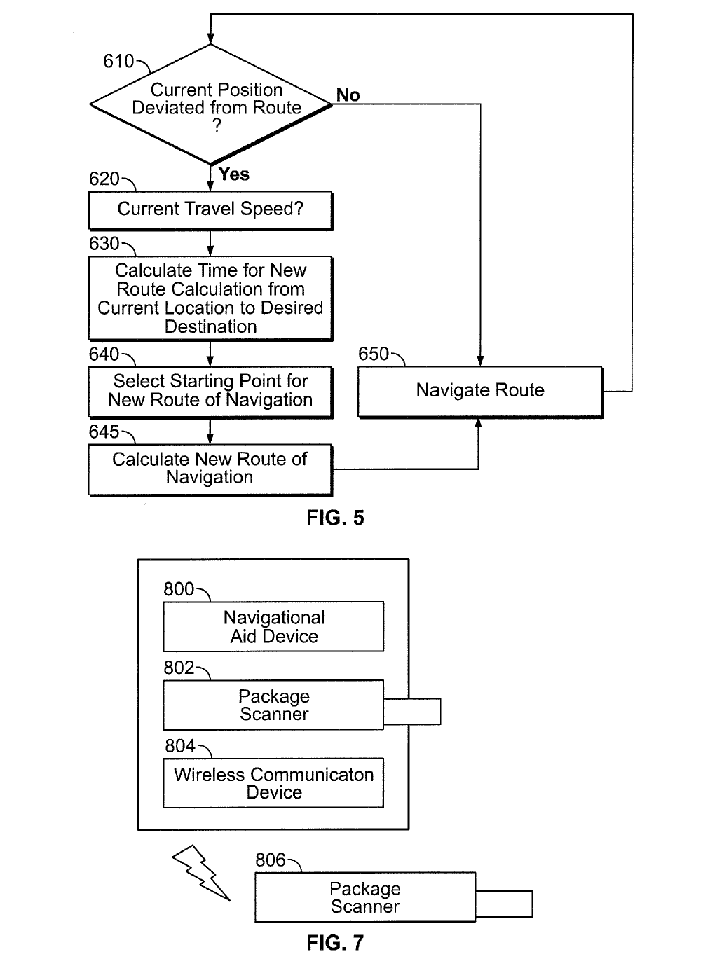

FIG. 5 is a flow diagram of one embodiment of a navigation aid method according to the teachings of the present invention. The navigation aid method includes a method for performing a route calculation within a navigation device or navigation system as described and explained in detail above in connection with FIGS. 3 and 4. As described above, a processor is used for processing signals which include input data from input devices, e.g. keypads, other input keys, or other inputs, GPS signals from GPS components, and data received from I/O ports in order to perform the methods described herein. In the embodiment shown in FIG. 5, the navigation aid method for performing a route calculation includes detecting when a navigation device has deviated from a first route and calculating the device's current location in block 610. The device's travel speed is calculated in block 620. A calculation time is determined for processing a second route from the device's current location to a desired destination in block 630. In one embodiment, the calculation time for processing a second route is estimated based on a distance from the device's current location to the desired destination. In one embodiment, the calculation time is estimated base on a complexity of the thoroughfares from the device's current location to the desired destination. In one embodiment, the calculation time for processing the second route is determined as a time equal to or greater than an actual previous calculation time. Of course, the calculation time may be estimated from a combination of the above methods.

Subsequently, in block 640, a starting point for the second route is selected based on the device's travel speed and the determined calculation time for processing the second route. Once the second route has been determined in block 645, the method proceeds to block 650 and navigates the route. As one of ordinary skill in the art will understand upon reading and comprehending this disclosure, the method embodiment described in FIG. 5 is repeatable, returning to block 610 in order to continually assess whether a then current position of the navigation device has deviated from the route. In one embodiment of the present invention, detecting when the device has deviated from the first route and calculating the device's current location includes using a global positioning system. According to the teachings of the present invention, selecting a starting point for the second route includes selecting a starting point forward on a current thoroughfare on which the device is located or traveling such that the device is on the route at a time when the new route calculation is completed. In one embodiment, selecting a starting point for the second route can include a starting point located at an end of a current thoroughfare on which the device is traveling.

In one method embodiment of the present invention, the device operates on data indicative of a set of travel habits of the device on each of the plurality of types of thoroughfares and stores the travel habit data in the memory. In one embodiment of the present invention, the travel habit data includes data relating to the thoroughfare classification, the speed classification of the thoroughfare, the time of day, and the historical travel speed of the device on the particular thoroughfare. In the invention, the device regularly calculates the device's current position. The display continuously displays the device's position and uses audio and/or visual instructions to navigate to the starting point of the new route calculation as well as to navigate along the new route.

According to the teachings of the present invention, and as used herein, the device travel speed includes a learned travel speed, an estimated travel speed, and a current travel speed. As used herein, a learned travel speed includes travel speed data that is obtained from the data indicative of a set of travel habits of the device on each of the plurality of types of thoroughfares. As used herein, an estimated travel speed includes travel speed data that is obtained from data indicative of a thoroughfare's classification type such as an interstate, city street, residential road and the like, and includes travel speed data that is obtained from the data indicative of a thoroughfare's speed classification such as a 25 mph, 55 mph, 75 mph or other roadway speed class on each of the plurality of types of thoroughfares. In one embodiment according to the teachings of the present invention, calculating the device's travel speed includes using a travel speed which is the greater of the device's current travel speed and the device's learned travel speed or estimated travel speed.

If the device is not determined to be on the new route after an actual first route calculation time then the device uses a second route calculation time and the device's travel velocity to set a new starting point, on the current thoroughfare on which the device is traveling, for another new route calculation. In one embodiment, the second route calculation time is equal to or greater than an actual first route calculation time.

In one embodiment of the present invention, the starting point is set at the end of the current thoroughfare on which the device is traveling. However, as will be understood by one of ordinary skill in the art upon reading this disclosure, there will be instances for which setting the starting point at the end of the current thoroughfare will not adequately set the starting point at a location forward of the device based on the device's travel speed and the necessary route calculation time. In those instances, the device of the present invention uses a set of criteria to analyze adjacency information and determine a straightest path in order to adjust the starting point for the new route calculation to, or sufficiently forward of, a location at which the device is likely to be at the end of the route calculation time, such that the device in on the route at a time when the new route calculation is completed. As used herein, the term adjacency information, or adjacencies, is intended to include any thoroughfare which intersects the current thoroughfare on which the device is traveling. Every place two thoroughfares intersect is termed a node. Thus, every node on a given thoroughfare connects that thoroughfare to an adjacency, or adjacent thoroughfare.

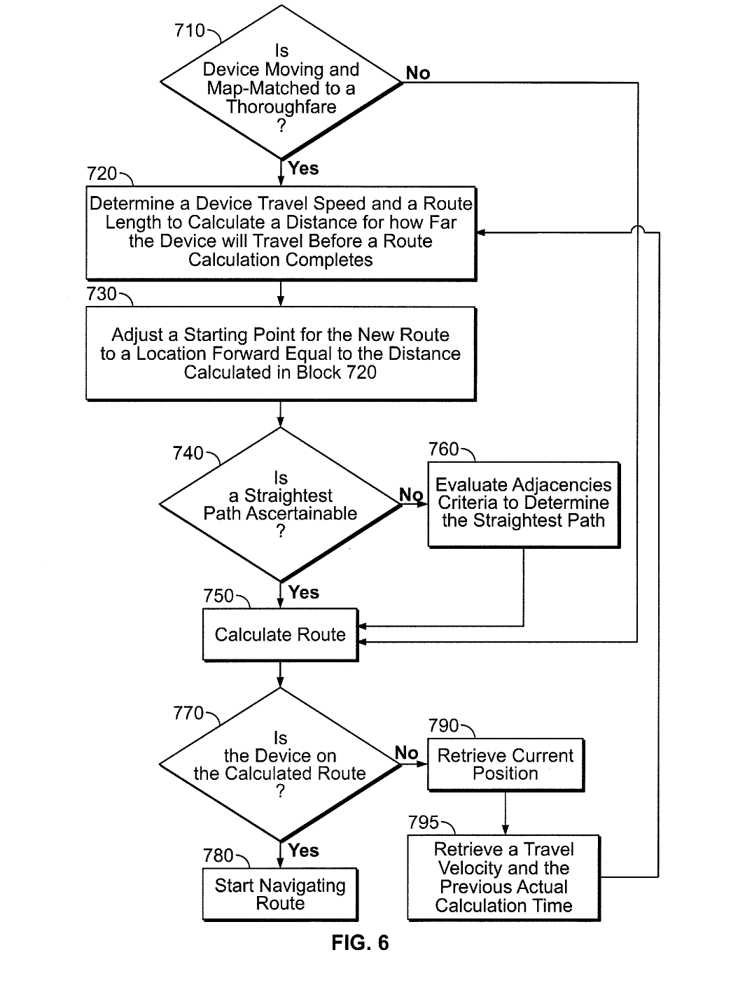

While the discussion of FIG. 6 contemplates calculating a new route when the device has deviated, such as by taking a detour, many of the steps may be used in other situations. For example, many of the steps of FIG. 6 may be used to calculate a detour route, before the device deviates. Furthermore, many of the steps of FIG. 6 may be used to calculate an initial route.

FIG. 6 is a flow diagram of another embodiment of a navigation aid method according to the teachings of the present invention. The navigation aid method includes a method for performing a route calculation within a navigation device or navigation system such as described and explained in detail above in connection with FIGS. 3 and 4. In addition, as described above, a processor is used for processing signals that include input data from user input devices, e.g. keypads or other inputs, GPS signals from GPS device/system components, and data received from I/O ports in order to perform the methods described herein.

As shown in FIG. 6, the navigation aid method for performing a route calculation includes determining whether the navigation device is moving and cartographically- or map-matched to one of a plurality of thoroughfares in block 710. In one embodiment as used herein, map-matched is intended to imply determining whether the device is located on a thoroughfare, and finding and indicating the location on the mapped thoroughfare that is closest to the unmatched location indicated by raw location date determined by the GPS. In one embodiment, determining whether the navigation device is moving and map-matched to one of a plurality of thoroughfares includes using a GPS. According to the method, if the device is not map-matched to a thoroughfare then the method determines the thoroughfare on which the device is most likely to be located. As one of ordinary skill in the art will understand upon reading this disclosure, the method includes retrieving a current position of the navigation device, cartographic data for a plurality of thoroughfares in a network, and data for a desired destination.

If the device is not moving, then once the current position of the navigation device is determined the method proceeds to block 750 and proceeds to calculate a route using a current position of the personal navigational device as a starting point for the route calculation.

On the other hand, if the navigation device is moving, the method proceeds to block 720 where the method determines a travel speed or velocity of the navigation device and determines a route calculation time for providing a route from the current geographic position of the navigation device to a desired destination. In one embodiment, the method estimates a route calculation time for providing a route from the current geographic position of the navigation device to a desired destination. The method in block 720 for determining a travel speed or velocity of the navigation device and determining a route calculation time includes that which has been described above in connection with FIG. 5. The method in block 720 includes using this information to calculate a distance predicting how far the navigation device will travel, along a thoroughfare on which the navigation device is moving, within the determined route calculation time such that the device is on the route at a time when the new route calculation is completed.

In block 730, the method adjusts a starting point for the new route calculation to a location forward along a current thoroughfare on which the device is traveling. In one embodiment, according to the teachings of the present invention, the method adjusts the starting point for the new route calculation forward along the current thoroughfare on which the device is traveling a distance equal to the distance calculated in block 720. In one embodiment, the method adjusts the starting point for the new route calculation forward along to the end of the current thoroughfare on which the device is traveling.

In block 740 the method includes determining whether a straightest path along the current thoroughfare on which the device is traveling is ascertainable in order to adjust the location of the starting point forward of the device. As one of ordinary skill in the art will understand upon reading this disclosure, the current thoroughfare on which the device is traveling can be approaching a node or intersection of streets such that there are a number of adjacencies approaching in the direction of travel. If a straightest path along the current thoroughfare on which the device is traveling is ascertainable in order to adjust the location of the starting point forward of the device such that the device will be on the route at a time when the new route calculation is completed, then the method proceeds to block 750 and calculates a new route using a starting point location which will be at or forward of the device at a time when the new route calculation completes.

However, in some instances where the device is approaching a node or intersection of streets, such that there are a number of adjacencies approaching in the direction of travel, a straightest path along the current thoroughfare on which the device is traveling is not immediately ascertainable. Therefore, simply adjusting the starting point for the new route calculation forward, even to the end of the current thoroughfare, will not suffice or does not provide an adequate distance, based on the travel speed of navigation device and the determined new route calculation time, such that the location of the starting point will be at or forward of the device at the time the new route calculation completes.

When the straightest path is not immediately ascertainable, the method proceeds to block 760 where the method evaluates a set of adjacency criteria to determine a straightest path and locate the starting point for the new route calculation somewhere along a chosen adjacency such that the starting point for the new route calculation will be at or forward of the device at a time when the new route calculation completes. According to the teachings of the present invention, the set of adjacency criteria includes, but is not limited to, the degree of turn angles between the thoroughfare on which the device is located and adjacent thoroughfares connected thereto by a node, thoroughfare names, thoroughfare classifications, speed classification of the thoroughfares, and other criteria of the like. Once the straightest path along the current thoroughfare on which the device is traveling is ascertainable in order to adjust the location of the starting point forward of the device, such that the device will be on the route at a time when the new route calculation is completed, then the method proceeds to block 750 where the method calculates the new route.

As shown in FIG. 6, once a new route has been calculated in block 750, the method proceeds to block 770. In block 770 the method determines whether the device location is on the calculated route. If so, the method proceeds to block 780 and begins navigating the new route, including navigating the device to the starting point for the new route. In one embodiment, the method navigates the new route using both visual and audio cues.

Alternatively, according to the teachings of the present invention, if the device location is not on the calculated route then the method proceeds to block 790 and retrieves the current position of the navigation device. Next, in block 795, the method retrieves a travel velocity for the device and additionally retrieves an actual calculation time which was required to perform the previous new route calculation.

According to the teachings of the present invention, the method then returns from block 795 to block 720 and repeats the sequence described above until a new route calculation has been completed with a starting point for the new route such that the device is on the new route at the time the new route calculation completes and eventually proceeds to block 780 to start navigating the route.

In some embodiments, the methods provided above are implemented as a computer data signal embodied in a carrier wave or propagated signal, that represents a sequence of instructions which, when executed by a processor, such as processor 436 in FIG. 3 or processor 504 in FIG. 4, cause the processor to perform the respective method. In other embodiments, methods provided above are implemented as a set of instructions contained on a computer accessible medium, such as memory 442 in FIG. 3 or mass data storage 512 in FIG. 4, capable of directing a processor, such as processor 436 in FIG. 3 or processor 504 in FIG. 4, to perform the respective method. In varying embodiments, the medium is a magnetic medium, an electronic medium, or an optical medium.

As one of ordinary skill in the art will understand upon reading this disclosure, the electronic components of device 400 shown in FIG. 3 and components of the system 500 shown in FIG. 4 can be embodied as computer hardware circuitry or as a computer-readable program, or a combination of both. In another embodiment, system 500 is implemented in an application service provider (ASP) system.

In some configurations and referring to FIG. 7, an electronic personal navigational aid device 800 configured to calculate a route and to automatically call a telephone number and deliver a pre-recorded message depending upon the location of the device 800 along the route is combined, in a single package, with a package scanner 802. The device 800 may be similar or identical to any of the devices 310,516 discussed above. The package scanner 802 may be, for example, a bar code reader or optical character recognition reader. Operation of the package scanner 802 may result in storage of information in a memory of the device 800 and/or transmission of the scanned data to a central server and/or call center, such as, for example, server 502. In addition to, or as an alternative to incorporating a package scanner 802, the device 800 may be provided with a wireless communication device 804, such as a Bluetooth or 802.11g wireless link, to communicate with a package scanner 806 separate from the device 800.

Embodiments of the present invention include software configured to instruct a processor to perform methods according to the teachings of the present invention. One of ordinary skill in the art will understand, upon reading and comprehending this disclosure, the manner in which a software program can be launched from a computer readable medium in a computer based system to execute the functions defined in the software program. One of ordinary skill in the art will further understand the various programming languages which may be employed to create a software program designed to implement and perform the methods of the present invention. The programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (A.P.I.) or interprocess communication techniques such as remote procedure call (R.P.C.), common object request broker architecture (CORBA), Component Object Model (COM), Distributed Component Object Model (DCOM), Distributed System Object Model (DSOM) and Remote Method Invocation (RMI). However, as will be appreciated by one of ordinary skill in the art upon reading this disclosure, the teachings of the present invention are not limited to a particular programming language or environment.

The above systems, devices and methods have been described, by way of example and not by way of limitation, with respect to improving accuracy, processor speed and ease of user interaction with a navigation device. That is, the systems, devices and methods provide for a personal navigational route planning device which is more efficient and accurate than current low cost systems, without requiring more expensive system resources. The systems, devices and methods of the present invention offer an improved personal navigational route planning device that provides more understandable, accurate and timely route calculation and utilization capabilities. Moreover, various configurations of the present invention can provide advance warning of an impending delivery or pickup to a customer, making it possible for the person to be ready for the driver when he or she arrives without the driver having to remember to call ahead at any particular time. Because the device requires little or no interaction with the driver, driver safety is not compromised, yet efficiency is increased because the likelihood of a driver having to wait a long time for someone to show up for a signature is reduced.

In summation, the device(s) of the present invention can aid a driver and other interested parties by automatically calling ahead to let a person know when to expect the driver. The device(s) of the present invention may also obtain information for the driver, in order to calculate or recalculate his or her route. For example, at the beginning of his shift, a driver may program his device 310 with information relating to a number of packages he is to deliver and/or customers he is to visit. The driver may do so in a number of ways. For example, the driver may download or otherwise enter such data into his device 310 or the driver may simply scan his packages. The device 310 may use this information, along with cartographic information and other information such as the driver's assigned pickup schedule, to calculate a route to each delivery or pickup address. Alternatively, the driver 310 may download the route into the device 310. As the driver progresses along the route, the device 310 calls each delivery or pickup address. For example, the device 310 may call each delivery address when the driver is five, ten, or fifteen minutes away play a prerecorded or synthesized message giving the ETA. The device 310 may also ask each delivery or pickup address whether they have packages to be picked up. If there are no packages to be picked up, or nobody answers and a signature is required, that address can be dropped from the route or placed at a later point in the route. Thus, the device 310 can automatically modify the route on the fly. The device 310 can also account for scheduled pickup or delivery times. For example, if a customer has set shipping hours, such information will be accommodated during route calculation. Furthermore, where it appears that the driver may arrive too early or too late, the device 310 may automatically recalculate the route, in order to assure the driver arrives on time. Additionally, the device 310 may account for priorities. For example, selected packages and/or customers may be given higher priority than others. In this case, the device calculates and/or recalculates the route to ensure that those packages and/or customers are served on time.

As used herein, the word “or” in the phrase “delivery or pickup” is to be construed as inclusive, i.e., a “delivery or pickup location” may refer to a location at which a delivery is made, a pickup is made, or both a delivery and a pickup are made. Also, unless further limited, the term “delivery” in isolation may be interpreted as meaning “delivery or pickup.” Furthermore, the term “personal” (as in, e.g., “personal navigational aid device”) should be understood as referring to a device that can be taken along with a person or inside a car.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. It is not a requirement of the present invention that every feature in the described embodiments be contained in every embodiment of the present invention. Also, embodiments of the present invention can combine features from more than one of the embodiments described herein. Thus, the scope of the invention includes any other applications in which the above systems, devices and methods are used, and should be determined with reference to the appended claims, along with the full scope of equivalents to which such claims are entitled.

What is claimed is:

1. An navigational method, comprising the steps of:
determining a position of a navigational device; and
automatically initiating, from the navigational device, a call to a contact number associated with a destination according to the position.

2. The method as set forth in claim 1, wherein the step of automatically initiating comprises calling the contact number using a cellular transceiver within the navigational device.

3. The method as set forth in claim 1, wherein the step of automatically initiating comprises calling the contact number using a cellular transceiver external to the navigational device.

4. The method as set forth in claim 1, wherein a processor of the navigational device calculates an estimated time enroute (ETE) to the destination and triggers the step of automatically initiating when the ETE to the destination corresponds to a predetermined ETE.

5. The method as set forth in claim 1, further comprising the step of producing a message over the call, the message including an estimated time enroute (ETE) to the destination.

6. The method as set forth in claim 5, wherein the message is predetermined and stored on the navigational device.

7. The method as set forth in claim 5, wherein the message is synthesized on the navigational device.

8. The method as set forth in claim 1, further comprising the step of automatically determining, from the call, whether any packages are waiting at the destination.

9. The method as set forth in claim 8, where there are no packages to be picked up at the destination, recalculating, on the navigational device, a route removing the destination from the route.

10. The method as set forth in claim 1, further including the step of recalculating, on the navigational device, a route according to the navigational device's progress along the route.

11. The method as set forth in claim 1, further including the step of scanning a package associated with the destination, thereby entering information related to the destination into the navigational device.

12. The method as set forth in claim 1, further comprising the step of receiving, into the navigational device, information relating to a plurality of destinations and calculating, in the navigational device, a sequential route to each destination.

13. The method as set forth in claim 1, wherein the device monitors progress along the route and recalculates the route to ensure arrival at the destination within a predefined time period.

14. The method as set forth in claim 1, further comprising the step of prompting a user of the navigational device regarding what to say over the call.

15. An navigational method, comprising the steps of:
receiving, into a navigational device, information relating to a plurality of destinations and calculating, in the navigational device, a sequential route to each destination;
monitoring the navigational device's progress along the route using a GPS receiver integral to the navigational device and recalculating the route according to a schedule;
calculating, within the navigational device, an estimated time enroute (ETE) to each destination;
automatically initiating, from the navigational device, a call to a contact number associated with each destination when the ETE to the destination corresponds to a predetermined ETE; and
producing a message over the call, the message including the ETE.

16. The method as set forth in claim 15, wherein the step of automatically initiating comprises calling the contact number using a cellular transceiver within the navigational device.

17. The method as set forth in claim 15, wherein the step of automatically initiating comprises calling the contact number using a cellular transceiver external to the navigational device.

18. The method as set forth in claim 15, further comprising the step of automatically determining, from the call, whether any packages are waiting at each destination.

19. The method as set forth in claim 18, where there are no packages to be picked up at the destination, recalculating, on the navigational device, the route removing the destination from the route.

20. An navigational method, comprising the steps of:
receiving, into a navigational device, information relating to a plurality of destinations and calculating, in the navigational device, a sequential route to each destination;
monitoring the navigational device's progress along the route using a GPS receiver integral to the navigational device and recalculating the route, on the navigational device, according to a schedule and priorities;
calculating, within the navigational device, an estimated time enroute (ETE) to each destination;
automatically placing a call, using a cellular transceiver within the navigational device, to a contact number associated with each destination when the ETE to the destination corresponds to a predetermined ETE; and
producing a predetermined message over the call, the message including the ETE and asking if there are packages to be picked up;
automatically determining, from the call, whether any packages are waiting at each destination, and where there are no packages to be picked up at one of the destinations and there are no packages to be delivered to that destination, recalculating, on the navigational device, the route removing that destination from the route.
